(19) United States
(12) Patent Application Publication
(10) Pub. No.: US 2006/0093751 A1
(43) Pub. Date: May 4, 2006

(54) System and methods for inkjet printing for flat panel displays

(75) Inventors: John M. White, Hayward, CA (US); Shinichi Kurita, San Jose, CA (US)

Correspondence Address: PATTERSON & SHERIDAN, LLP, 3040 POST OAK BOULEVARD, SUITE 1500, HOUSTON, TX, 77056, US

(73) Assignee: APPLIED MATERIALS, INC.

(21) Appl. No.: 11/167,516

(22) Filed: Jun. 27, 2005

Related U.S. Application Data
(63) Continuation-in-part of application No. 11/019,967, filed on Dec. 22, 2004.
(60) Provisional application No. 60/625,550, filed on Nov. 4, 2004.

(51) Int. Cl. B41J 2/01; B05D 5/06; B05D 1/32

(52) U.S. Cl. 427/466; 427/162; 347/1

(57) ABSTRACT

A system for inkjet printing, which includes an inkjet printing module support having one or more inkjet heads disposed thereon. The one or more inkjet heads are configured to move along a first axis. The system further includes a substrate stage configured to move along a second axis that is perpendicular to the first axis. The substrate stage is configured to support a substrate having one or more ink landing positions disposed thereon in a pattern that is not aligned with either the first axis or the second axis. The system further includes a system controller configured to simultaneously move the one or more inkjet heads along the first axis and move the substrate stage along the second axis during a printing operation such that the one or more inkjet heads dispense ink into the ink landing positions.

### CROSS-REFERENCE TO RELATED APPLICATIONS

This application is a continuation-in-part of co-pending commonly assigned U.S. patent application Ser. No. 11/019,967, filed Dec. 22, 2004 and entitled APPARATUS AND METHODS FOR AN INKJET HEAD SUPPORT HAVING AN INKJET HEAD CAPABLE OF INDEPENDENT LATERAL MOVEMENT, and claims benefit of U.S. Provisional Patent Application Ser. No. 60/625,550, filed Nov. 4, 2004 and entitled APPARATUS AND METHODS FOR FORMING COLOR FILTERS IN A FLAT PANEL DISPLAY BY USING INKJETTING. Each of the aforementioned related patent applications is herein incorporated by reference.

### BACKGROUND OF THE INVENTION

1. Field of the Invention

Embodiments of the present invention generally relate to electronic device manufacturing and more particularly to apparatus and methods for forming color filters in a flat panel display using inkjetting.

2. Description of the Related Art

Flat panel displays (FPDs) have become the display technology of choice for computer terminals, visual entertainment systems, and personal electronic devices such as cellular phones, personal digital assistants (PDAs), and the like. Liquid crystal displays (LCDs), and especially active matrix liquid crystal displays (AMLCDs), have emerged as the most versatile and robust of the commercially available FPDs. A basic element of the LCD technology is a color filter through which light is directed to produce a colored visual output. The color filter is made up of pixels, which are typically red, green, and blue and are distributed in a pattern or array within an opaque (black) matrix which allows for improved resolution of the color filtered light.

Traditional methods of producing these color filters, such as dyeing, lithography, pigment dispersion, and electrodeposition, all have a major disadvantage of requiring the sequential introduction of the three colors. That is, a first set of pixels having one color is produced by a series of steps, whereupon the process must be repeated twice more to apply all three colors. An area for improvement in the technology applicable to color filter production has been the introduction of improved dispensing devices, such as inkjets. By using an inkjet system, all three colors can be applied within the color filter matrix in one step and hence the process need not be carried out in triplicate.

One problem with effective employment of inkjet printing is that it is difficult to dispense ink accurately on a substrate, while maintaining a high throughput. Accordingly, there is a need for improved methods and apparatus to efficiently position inkjet heads above ink landing positions on a substrate to reduce the number of printing passes required for dispensing ink on the substrate.

### SUMMARY OF THE INVENTION

Embodiments of the invention are directed to a method for inkjet printing. The method includes disposing a substrate on a substrate support and providing an inkjet printing module support having one or more inkjet heads disposed thereon. The one or more inkjet heads are disposed above the substrate. The method further includes performing a printing operation by moving the one or more inkjet heads along a first axis and moving the substrate along a second axis perpendicular to the first axis such that the one or more inkjet heads dispense ink into one or more ink landing positions disposed in a pattern that is not aligned with either the first axis or the second axis.

Embodiments of the invention are also directed to a method for inkjet printing. The method includes moving a substrate along a first axis toward an inkjet printing module support having one or more inkjet heads disposed thereon, while keeping a first inkjet head stationary such that ink from the first inkjet head is dispensed into one or more ink landing positions in a first color filter region disposed on the substrate. The method further includes moving the first inkjet head along a second axis perpendicular to the first axis and moving the substrate toward the inkjet printing module support, while keeping the first inkjet head stationary such that ink from the first inkjet head is dispensed into one or more ink landing positions in a second color filter region disposed on the substrate.

Embodiments of the invention are also directed to a system for inkjet printing, which includes an inkjet printing module support having one or more inkjet heads disposed thereon. The one or more inkjet heads are configured to move along a first axis. The system further includes a substrate stage configured to move along a second axis that is perpendicular to the first axis. The substrate stage is configured to support a substrate having one or more ink landing positions disposed thereon in a pattern that is not aligned with either the first axis or the second axis. The system further includes a system controller configured to simultaneously move the one or more inkjet heads along the first axis and move the substrate stage along the second axis during a printing operation such that the one or more inkjet heads dispense ink into the ink landing positions.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates a perspective view of an inkjet printing apparatus in accordance with one or more embodiments of the invention.

FIG. 2 illustrates a top view of the inkjet heads disposed above the substrate having display objects in connection with one or more embodiments of the invention.

FIG. 3 illustrates a top view of each inkjet heads being oriented at a pitch angle α relative to the respective display object in connection with one or more embodiments of the invention.

FIG. 4 is an illustrative top view of nine pixels disposed on a portion of one of the display objects.

FIG. 5 illustrates a flowchart of a method for forming color filters on one or more display objects in accordance with one or more embodiments of the invention.

FIG. 6 illustrates the movements of an inkjet head with respect to a substrate in connection with forming a mosaic color filter pattern in accordance with one or more embodiments of the invention.

FIG. 7 illustrates the movements of another inkjet head with respect to the substrate in connection with forming the mosaic color filter pattern in accordance with one or more embodiments of the invention.

FIG. 8 illustrates another example of a pattern that is not aligned with either the X-axis or the Y-axis in accordance with one or more embodiments of the invention.

### DETAILED DESCRIPTION

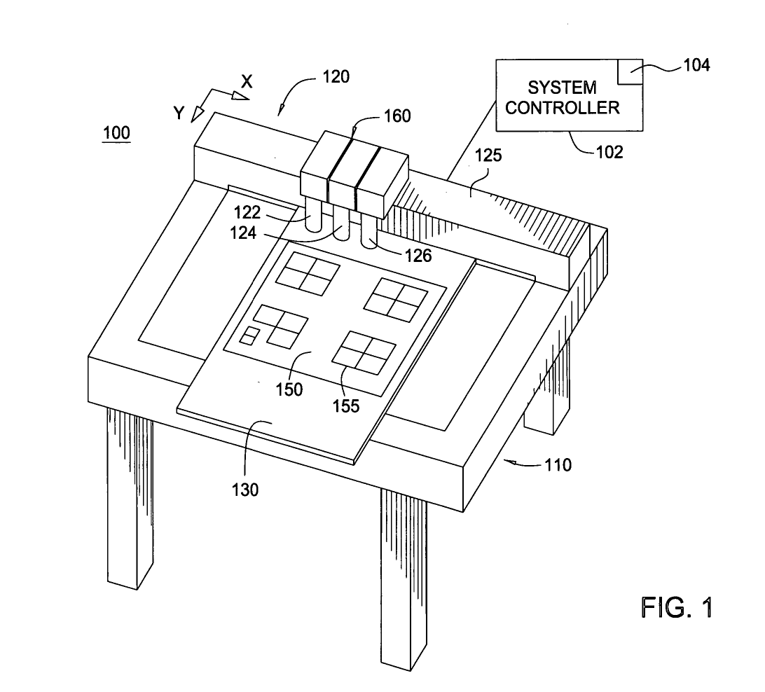

FIG. 1 illustrates a perspective view of an inkjet printing apparatus 100 in accordance with one or more embodiments of the invention. The inkjet printing apparatus 100 may be configured to form color filters in flat panel displays. The inkjet printing apparatus 100 includes a stage positioning system 110 and an inkjet printing system 120. The stage positioning system 110 includes a substrate stage 130, which may be configured to move in the Y-axis direction. The substrate stage 130, however, may also be configured to move in the X-axis direction. The substrate stage 130 may be an X-Y table, such as those that are commonly used in semiconductor processing. A substrate 150 is configured to be disposed on the substrate stage 130. The substrate 150 may include one or more display objects 155 into which ink may be dispensed during inkjet printing. The substrate 150 may be made of glass, polymers, and/or any other suitable material.

The substrate stage 130 may be moved by a stage moving device (not shown), which may have one or more motors or actuation devices, such as a linear motor, for moving the substrate stage 130 in either the Y-axis or in the X-axis direction. The stage moving device may also be configured to rotate the substrate stage 130. This rotation feature may be used to align the substrate 150 and the display objects disposed thereon with an inkjet printing module 160 (described below) of the inkjet printing system 120. The rotation capabilities of the substrate stage 130 facilitate optimal alignment of the substrate 150 with the inkjet printing module 160, which may result in a more accurate and efficient inkjetting operation. To that end, the stage moving device may include a rotational motor configured to rotate the substrate stage 130 in either clockwise or counterclockwise direction. Other details of the substrate stage 130 and any components related thereto (e.g., a controller, a substrate securing device and the like) are provided in U.S. Provisional Patent Application Ser. No. 60/625,550, filed Nov. 4, 2004 and entitled APPARATUS AND METHODS FOR FORMING COLOR FILTERS IN A FLAT PANEL DISPLAY BY USING INKJETTING, which is incorporated herein by reference in its entirety.

As briefly mentioned above, the inkjet printing system 120 includes the inkjet printing module 160, which may include three inkjet heads 122, 124 and 126. Each inkjet head 122, 124 and 126 may be used to dispense ink. As an example, each inkjet head 122, 124 and 126 may dispense a different color ink, depending upon the color system being utilized. For example, inkjet head 122 may dispense red ink, inkjet head 124 may dispense green ink and inkjet head 126 may dispense blue ink. Other ink colors, such as cyan, yellow, magenta or white, may also be dispensed by the inkjet heads 122, 124 and 126. Any one or more of the inkjet devices may dispense the same color ink or a clear ink. Although described as being equipped with three inkjets heads, the inkjet printing module 160 may have any number of inkjet heads, depending upon the application or use of the inkjet printing apparatus 100.

In addition to the inkjet printing module 160, the inkjet printing system 120 may further include an inkjet printing module support 125 on which the inkjet printing module 160 is mounted. The inkjet printing module 160 may be moveable along the inkjet printing module support 125 by an inkjet positioning device (not shown). The inkjet positioning device may include one or more motors or actuation devices for moving the inkjet printing module 160 along the inkjet printing module support 125 in the X-axis direction. The inkjet positioning device may also include one or more motors or actuation devices for moving the inkjet printing module 160 in the Y-axis direction.

Each of the inkjet heads 122, 124 and 126 may include other components related thereto, such as a height adjustment device, a head rotation actuator device, an ink reservoir and the like. Details of each component related to the inkjet heads 122, 124 and 126 are provided in U.S. Provisional Patent Application Ser. No. 60/625,550, filed Nov. 4, 2004 and entitled APPARATUS AND METHODS FOR FORMING COLOR FILTERS IN A FLAT PANEL DISPLAY BY USING INKJETTING, which is incorporated herein by reference in its entirety. The head rotation actuator device may be configured to rotate the inkjet head. In this manner, the pitch or the angle at which an inkjet head is oriented relative to a display object on a substrate can be changed depending upon the printing application. Each inkjet head may have numerous nozzles, e.g., 128 nozzles. The droplets may be dispensed at frequencies between about 0.01 kHz to about 100 kHz. The size of each droplet may be between about 2 μm to about 100 μm in diameter. The speed at which the droplets are dispensed may be between about 2 m/s to about 12 m/s. Examples of inkjet heads described herein include Spectra SE128A, SX128, or SM128 inkjet head assemblies. The Spectra SE-128 inkjet head assembly has 128 nozzles, with each nozzle having a diameter of 38 μm and a space between adjacent nozzles of 508 μm. The Spectra SE-128 inkjet head assembly can dispense ink droplets having a volume of approximately 25 to 35 pico liters and can operate at a frequency of about 40 kHz.

Further, each of the inkjet heads 122, 124 and 126 may be independently moveable in one or more lateral directions relative to another of the inkjet heads 122, 124 and 126. Each of the inkjet heads 122, 124 and 126 may also be rotatable independently relative to the inkjet printing module support 125. Further, the inkjet heads 122, 124 and 126 may be independently moveable in one or more vertical directions (e.g., along a z-axis) away from or toward the substrate 150. The lateral movement, rotation, and vertical movement may be performed independently, in any sequence, and/or substantially simultaneously. For example, each inkjet head may be (1) laterally moved and thereafter rotated; (2) each inkjet head may be rotated and thereafter laterally moved; and/or (3) each inkjet head may be simultaneously rotated and laterally moved. Similarly, vertical movement of an inkjet head may be performed before, after or during lateral movement and/or rotation of the inkjet head. In any case, the lateral motion, vertical motion and/or rotation of one inkjet head may occur while the remaining inkjet heads are held stationary.

As briefly mentioned above, the inkjet printing module support 125 may be moved in both an X-axis direction and a Y-axis direction. In this regard, once inkjet heads 122, 124 and 126 have been laterally moved and/or rotated to a given position and/or angular orientation, the inkjet printing module support 125 may affect the movement of the positioned and/or oriented inkjet heads 122, 124 and 126 over the respective display objects 155 to effectuate an ink printing operation on the display objects 155. Other details regarding the various manner in which the inkjet heads may be moved independently of each other are provided in U.S. patent application Ser. No. 11/019,967, filed Dec. 22, 2004 and entitled APPARATUS AND METHODS FOR AN INKJET HEAD SUPPORT HAVING AN INKJET HEAD CAPABLE OF INDEPENDENT LATERAL MOVEMENT, which is incorporated herein by reference in its entirety.

The inkjet printing apparatus 100 may further include a system controller 102 and an image data file 104, which may be an integral component of the system controller 102 or an external device. The system controller 102 may be in communication with the inkjet printing module support 125 and the inkjet heads 122, 124 and 126 to control and monitor the operation and movement of the inkjet printing module support 125 and the inkjet heads 122, 124 and 126. The system controller 102 may also be in communication with the substrate stage 130 to control the movement of the substrate stage 130 in both the X-axis and the Y-axis directions.

The system controller 102 may be any suitable computer or computer system, including, but not limited to a mainframe computer, a minicomputer, a network computer, a personal computer, and/or any suitable processing device, component, or system. The system controller 102 may control the lateral movement of the inkjet heads 122, 124 and 126 in the X-axis and the Y-axis directions. The system controller 102 may also control the rotation of each of the inkjet heads 122, 124 and 126 relative to the inkjet printing module support 125.

The image data file 104 may contain data and/or information regarding the substrate 150 and/or display objects 155 to be processed by the inkjet printing apparatus 100. For example, the image data file 104 may include information that can be used by the system controller 102 to control the movement and printing operations of each of the inkjet heads 122, 124 and 126 and the substrate stage 130. As such, the system controller 102 may use the information contained in the image data file 104 in controlling the printing or inkjetting operations on the display objects 155.

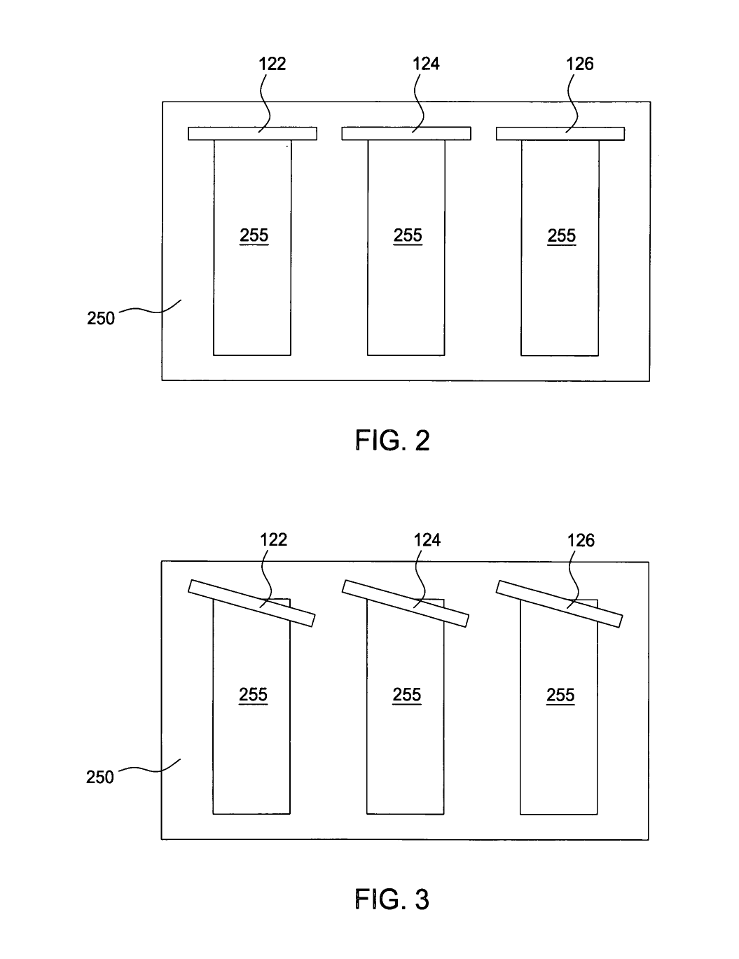

FIG. 2 illustrates a top view of the inkjet heads 122, 124 and 126 disposed above the substrate 250 having display objects 255 in connection with one or more embodiments of the invention. The inkjet heads 122, 124 and 126 are displayed as perpendicular to the display objects 255. However, one or more of the inkjet heads 122, 124 and 126 may be rotated to any appropriate angle relative to the display objects 255. Each of the inkjet heads 122, 124 and 126 may be rotated by the respective head rotation actuator device to “pitch” or orient the inkjet head at an angle relative to a respective display object. The angle at which the respective inkjet head is oriented relative to the display object may be referred to as the pitch or pitch angle.

FIG. 3 illustrates a top view of each inkjet heads 122, 124 and 126 being oriented at a pitch angle a relative to the respective display object 255 in connection with one or more embodiments of the invention. The pitch angle may vary from about 0 degrees to about 90 degrees.

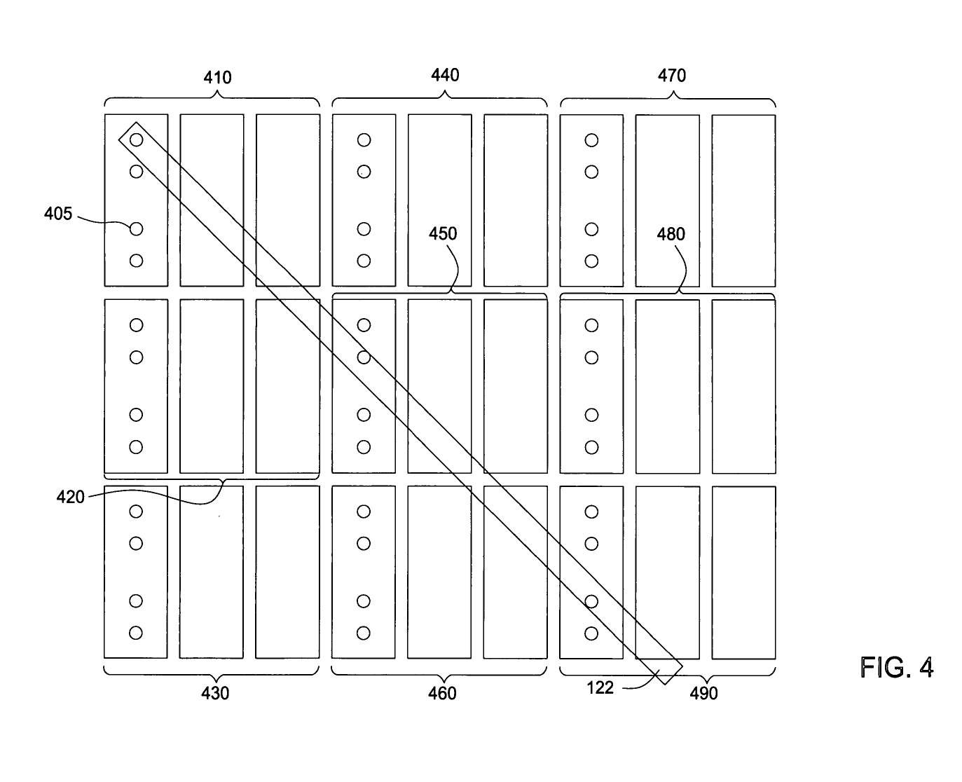

FIG. 4 illustrates a top view of nine pixels 410, 420, 430, 440, 450, 460, 470, 480 and 490 disposed on a portion of one of the display objects 255. Each pixel may have three sub pixels, each for a different color filter region that can be used to form color filters. In one embodiment, the colors red, green and blue may be used for making color filters for the respective pixels. For example, the color red may be assigned to the leftmost color filter region, the color green may be assigned to the center color filter region and the color blue may be assigned to the rightmost color filter region. The color filter regions may be assigned in different order or using different colors.

Each color filter region (e.g., 410) may have one or more predetermined ink landing positions (e.g., 405) where a color ink drop may be deposited by inkjet head 122. As an example, four ink landing positions are shown for the leftmost color filter region 410. Although four ink landing positions are shown in each color filter region, any number of ink landing positions may be used in each color filter region. As the display object 255 is moved beneath the respective inkjet head, a drop of ink is deposited on each desired ink landing position. After the respective ink drops have been deposited on all of desired ink landing positions for a given processing period, the ink may be cured to complete the manufacture of the respective pixels of the display object. The ink may be cured by various methods and devices described in U.S. Provisional Patent Application Ser. No. 60/625,550, filed Nov. 4, 2004 and entitled APPARATUS AND METHODS FOR FORMING COLOR FILTERS IN A FLAT PANEL DISPLAY BY USING INKJETTING, which is incorporated herein by reference in its entirety.

The manner in which inkjet heads dispense ink to ink landing positions may be controlled by the system controller 102. The system controller 102 may operate pursuant to a computer program that utilizes information contained in the image data file 104 that is generated by an image data processor (not shown) and that corresponds to the substrate 150 being processed. The system controller 102 and the image data processor may be described in more detail in U.S. Provisional Patent Application Ser. No. 60/625,550, filed Nov. 4, 2004 and entitled APPARATUS AND METHODS FOR FORMING COLOR FILTERS IN A FLAT PANEL DISPLAY BY USING INKJETTING, which is incorporated herein by reference in its entirety.

Referring back to FIG. 1, during the inkjet printing process, the substrate stage 130 and the inkjet printing module 160 may move with respect to each other in either the X-axis direction or the Y-axis direction. For example, the substrate stage 130 may be moved in the Y-axis direction underneath the inkjet printing module 160 while the inkjet printing module 160 remains stationary. In another example, the substrate stage 130 may be stationary while the inkjet printing module 160 is moved in the X-axis direction. As such, the inkjet printing process may involve instances in which the inkjet printing module 160 remains stationary while the substrate stage 130 is moved relative to the inkjet printing module 160 and instances in which the substrate stage 130 remains stationary while the inkjet printing module 160 is moved relative to the substrate stage 130, or any combination of the above in any desired order. Further, the inkjet printing module 160 and the substrate stage 130 may be moved simultaneously during all or a portion of the inkjet printing process. The rate at which the substrate stage 130 or the inkjet printing module 160 moves may vary from about 500 m/sec to about 1000 m/sec.

As mentioned above the image data file 104 may be used by the system controller 102 to control the printing or inkjetting operation on the display objects. For example, the image data file 104 may be used to control ink landing positioning on various ink landing positions. Accordingly, the image data file 104 may be generated using one or more substrate layout data, information regarding the number of ink drops to be deposited in each pixel's color filter region, the position and/or spacing of the ink drops for each color filter region, any desired or required offset distances of an ink landing position from a pixel's edge and information regarding the Y-axis resolution of the image and/or the display object. Details regarding the manner in which the image data file 104 is generated are provided in U.S. Provisional Patent Application Ser. No. 60/625,550, filed Nov. 4, 2004 and entitled APPARATUS AND METHODS FOR FORMING COLOR FILTERS IN A FLAT PANEL DISPLAY BY USING INKJETTING, which is incorporated herein by reference in its entirety.

Substrate layout data may include data regarding the substrate, the type of substrate, the display objects on the substrate, information regarding the pixels on the substrate, the length of the substrate in the X-axis direction and in the Y-axis direction, the top margin of the substrate, the bottom margin of the substrate, the left side margin of the substrate, the right side margin of the substrate, the number and sizes of any gap or gaps between display objects, the number of display objects in the X-axis direction and the number of display objects in the Y-axis direction. Substrate layout data may be used to determine the X and Y coordinate information for each pixel and the pixel color filter regions contained on the display objects.

The number and position of the ink landing positions along with the substrate layout data may be used to determine the position of each ink drop to be deposited in a respective pixel color filter region. In this manner, the image data processor may be programmed to automatically determine the respective ink landing positions to evenly distribute the ink drops inside a pixel's color filter region.

In some instances, the position of an ink drop may be shifted from its desired location due to errors in motion of the substrate stage 130. In extreme cases, a drop may land outside a pixel region and become a defect. To avoid such errors, dynamic adjustment of inkjet head position during inkjetting may be employed. For example, a visualization device, an inspection device or other similar devices, may be employed to check the inkjet heads and nozzle positions relative to a substrate pixel prior to an inkjet printing operation. Inkjet head and/or nozzle position information may be fed to the system controller 102 and an offset may be determined to correct any positioning error.

In addition, inkjet head position and/or nozzle firing/jetting time may be adjusted on the fly, i.e., while the substrate stage 130 is in motion, based on the determined offset. For example, assuming that the substrate stage 130 travels along a Y-axis direction at a constant rate during inkjetting, an error in the Y-axis position of an inkjet head may be compensated for by jetting from a nozzle of the inkjet early, late or not at all. Likewise, an error in an X-axis direction position (e.g., perpendicular to the substrate stage 130's direction of travel) may be compensated for by adjusting the X-axis position of the inkjet head prior to printing (e.g., by moving the inkjet head to the left or right relative to the direction of travel so that a nozzle is properly positioned over a pixel location). Such an on-the-fly, self compensation mechanism may greatly improve printing accuracy by compensating for dynamic errors in inkjet head position. Further, the in-line position, lateral position, height, pitch, yaw, etc., of an inkjet head may be dynamically adjusted while the substrate stage 130 remains in motion.

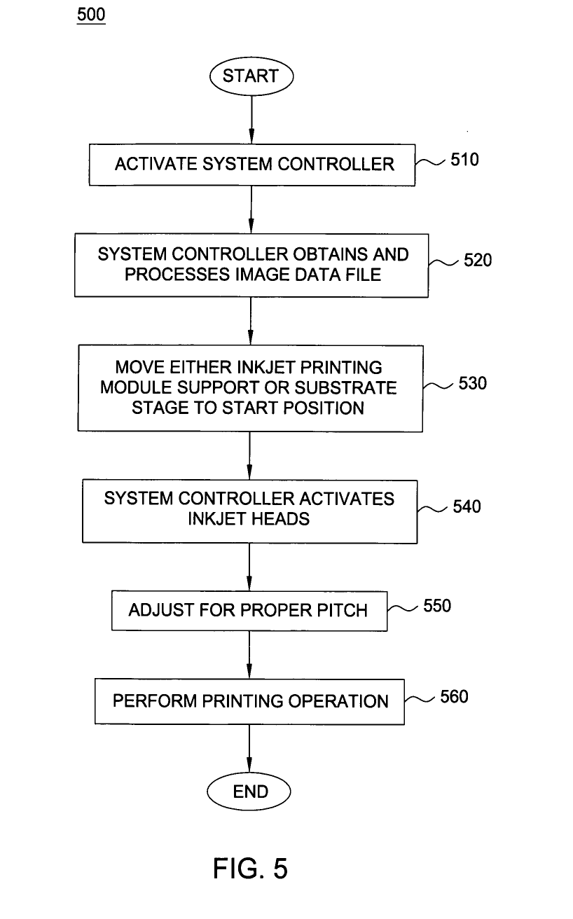

FIG. 5 is a flowchart of a method 500 for forming color filters on one or more display objects 155 in accordance with one or more embodiments of the invention. Once the substrate 150 containing the display objects 155 is placed on the substrate stage 130, the operation of the inkjet printing apparatus 100 may begin at step 510, at which the system controller 102 is activated. At step 520, the system controller 102 obtains and processes the image data file for the substrate 150.

At step 530, if the inkjet printing module support 125 is configured to remain stationary while the substrate stage 130 moves, the system controller 102 moves the substrate stage 130 to a home or start position for the substrate 150. Alternatively, if the substrate stage 130 is configured to remain stationary while the inkjet printing module support 125 moves, the system controller 102 moves the inkjet printing module support 125 to a home or start position. At step 540, the system controller 102 activates each of the inkjet heads 122, 124 and 126, e.g., by supplying ink to the inkjet heads or otherwise preparing the inkjet heads for printing.

At step 550, the system controller 102 commences the printing process by adjusting the lateral positions of each of the inkjet heads 122, 124 and 126. For instance, the inkjet heads 122, 124 and 126 may be adjusted for proper positioning during printing of ink into the pixels. During this step, the system controller 102 may also rotate one or more of the inkjet heads 122, 124 and 126 to the proper pitch angle relative to the display objects on the substrate 150.

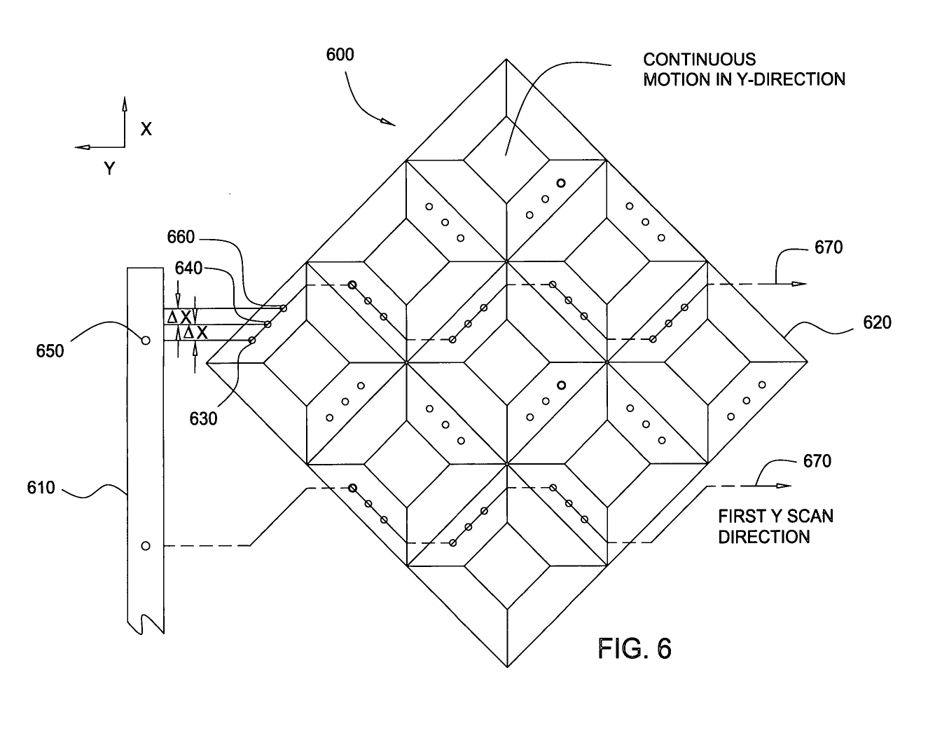

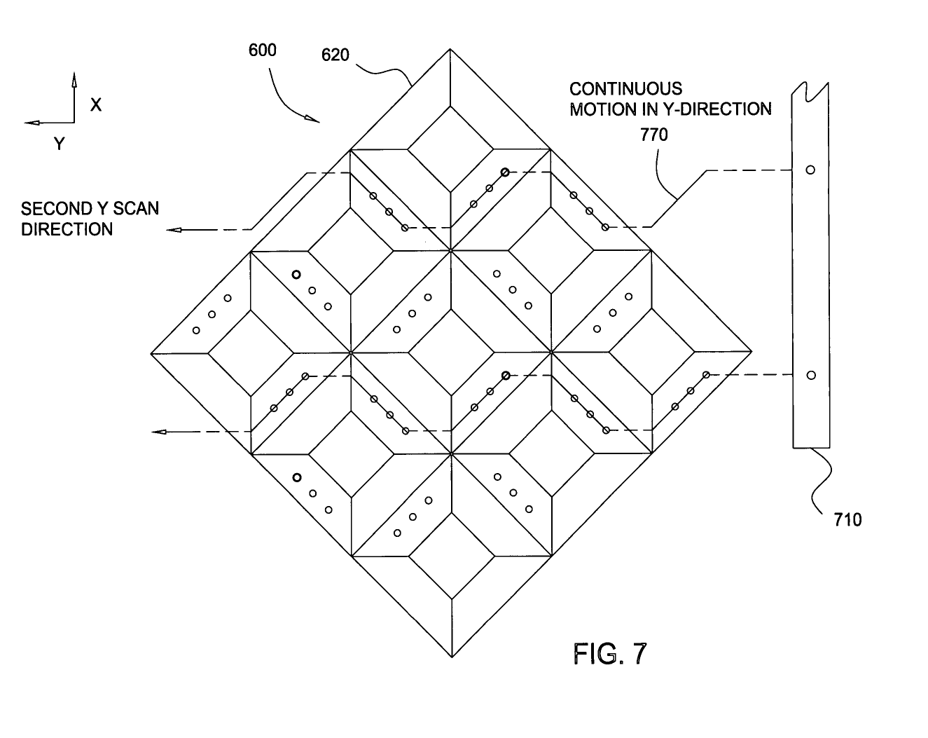

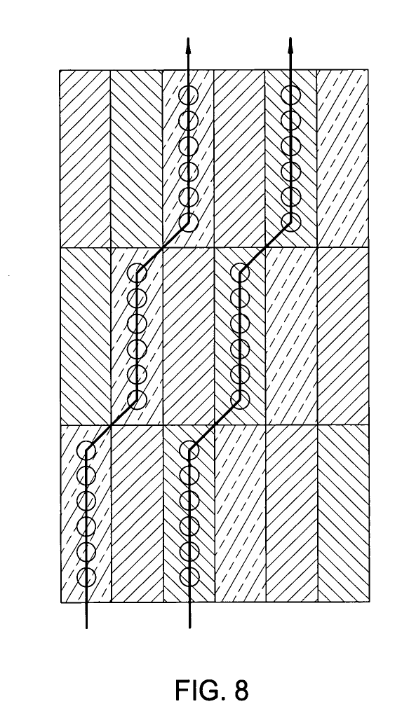

At step 560, the system controller 102 commences the print passing operation of the inkjet printing module support 125 and each of the inkjet heads 122, 124 and 126. The print passing operation may include passing the substrate 150 below the inkjet printing module support 125 in the Y-axis direction from a starting edge to a stopping edge to print ink in all applicable display pixels on the display objects 155 on the substrate 150. In one embodiment, the system controller 102 moves the substrate stage 130 along the Y-axis direction and the inkjet printing module support 125 along the X-axis direction so that the inkjet heads 122, 124 and 126 may dispense ink along a pattern that is not aligned with either the X-axis or the Y-axis. For example, the pattern may be a diagonal pattern, as described in FIGS. 6 and 7. FIG. 8 illustrates another example of a pattern that is not aligned with either the X-axis or the Y-axis.

FIG. 6 illustrates the movements of an inkjet head 610 with respect to a substrate 620 in connection with forming a mosaic color filter pattern 600 in accordance with one or more embodiments of the invention. For the first ink drop, the inkjet head 610 remains stationary while the substrate 620 moves in the Y-axis direction toward the inkjet head 610 such that a first ink from nozzle 650 is dispensed into an ink landing position 630. For the second ink drop, the inkjet head 610 moves along the X-axis by a distance Δx toward an ink landing position 640 while the substrate 620 moves in the Y-axis direction by a distance Δy such that a second ink from nozzle 650 is dispensed into the ink landing position 640. Distance Δx represents the x component of the distance between ink landing position 630 and ink landing position 640. Distance Δy represents the y component of the distance between ink landing position 630 and ink landing position 640. Distance Δx, distance Δy, the respective speeds at which the inkjet head 610 and the substrate 620 move may be determined by the system controller 102 according to the image data file for the substrate 620. For the third ink drop, the inkjet head 610 moves along the X-axis by a distance 2Δx from ink landing position 630 toward an ink landing position 660 while the substrate 620 moves in the Y-axis direction by a distance 2Δy from ink landing position 630 such that a third ink from nozzle 650 is dispensed into the ink landing position 660.

The inkjet head 610 continues to move in the X-axis direction while the substrate 620 moves in the Y-axis direction until the inkjet head 610 dispenses ink to all the ink landing positions that are configured to be filled with the ink from the inkjet head 610. FIG. 6 also illustrates the path or scan 670 for the inkjet head 610 during the first printing pass.

FIG. 7 illustrates the movements of an inkjet head 710 with respect to the substrate 620 in connection with forming the mosaic color filter pattern 600 in accordance with one or more embodiments of the invention. The movements of the inkjet head 710 with respect to the substrate 620 are similar to the movements of the inkjet head 610, except that the substrate 620 moves in the opposite Y-axis direction during the second printing pass. FIG. 7 also illustrates the path or scan 770 for the inkjet head 710 during the second printing pass.

In this manner, the rest of the ink landing positions within each color filter region may be filled during subsequent printing passes using different inkjet heads configured to dispense different colors. The inkjet heads may be configured to move in both forward and reverse directions along the X-axis during each printing pass. The substrate 620 may be configured to move continuously in the both forward and reverse directions along the Y-axis during each printing pass.

The foregoing description discloses only particular embodiments of the invention. Modifications of the above disclosed methods and apparatus which fall within the scope of the invention will be readily apparent to those of ordinary skill in the art. For example, embodiments of the present invention may be applied to semiconductor processing and/or electronic device manufacturing. More particularly, resist patterns may be jetted onto substrates which may include glass, polymers, semiconductors, and/or any other suitable materials that are practicable. Thus, the jetted material may include ink, polymers, or any other suitable material that is practicable.

While the foregoing is directed to embodiments of the present invention, other and further embodiments of the invention may be devised without departing from the basic scope thereof, and the scope thereof is determined by the claims that follow.

What is claimed is:

1. A method for inkjet printing, comprising:
disposing a substrate on a substrate support;
providing an inkjet printing module support having one or more inkjet heads disposed thereon, wherein the one or more inkjet heads are disposed above the substrate; and
performing a printing operation by moving the one or more inkjet heads along a first axis and moving the substrate along a second axis perpendicular to the first axis such that the one or more inkjet heads dispense ink into one or more ink landing positions disposed in a pattern that is not aligned with either the first axis or the second axis.

2. The method of claim 1, wherein the pattern is a diagonal pattern.

3. The method of claim 1, wherein performing the printing operation comprises moving the inkjet heads in one of a forward direction and a reverse direction along the first axis, wherein the forward direction is opposite the reverse direction.

4. The method of claim 1, wherein performing the printing operation comprises moving the substrate in one of a forward direction and a reverse direction along the second axis, wherein the forward direction is opposite the reverse direction.

5. The method of claim 1, wherein performing the printing operation comprises:
moving the substrate toward the inkjet printing module support while keeping the one or more inkjet heads stationary such that a first ink from a first inkjet head is dispensed into a first ink landing position on the substrate; and
moving the substrate toward the inkjet printing module support and moving the first inkjet head along the first axis toward a second ink landing position on the substrate such that a second ink from the first inkjet head is dispensed into the second ink landing position.

6. The method of claim 5, wherein moving the first inkjet head toward the second ink position comprises moving the first inkjet head by a distance equivalent to the x component of the distance between the first ink landing position and the second ink landing position.

7. The method of claim 6, wherein moving the substrate toward the inkjet printing module support comprises moving the substrate by a distance equivalent to the y component of the distance between the first ink landing position and the second ink landing position, while the first inkjet head is moved by the distance equivalent to the x component of the distance between the first ink landing position and the second ink landing position.

8. The method of claim 1, wherein the movements of the inkjet heads and the substrate are determined by a system controller according to an image data file for the substrate.

9. The method of claim 1, wherein each ink landing position is disposed in a color filter region.

10. The method of claim 1, wherein performing the printing operation comprises:
moving the substrate in a forward direction along the second axis during a first printing pass;
moving the substrate in a reverse direction along the second axis during a second printing pass, wherein the forward direction is opposite the reverse direction.

11. A method for inkjet printing, comprising:
moving a substrate along a first axis toward an inkjet printing module support having one or more inkjet heads disposed thereon, while keeping a first inkjet head stationary such that ink from the first inkjet head is dispensed into one or more ink landing positions in a first color filter region disposed on the substrate;
moving the first inkjet head along a second axis perpendicular to the first axis; and
moving the substrate toward the inkjet printing module support while keeping the first inkjet head stationary such that ink from the first inkjet head is dispensed into one or more ink landing positions in a second color filter region disposed on the substrate.

12. The method of claim 1, wherein the first color filter region and the second color filter region are disposed diagonally to each other.

13. The method of claim 1, wherein the first color filter region and the second color filter region are disposed in a pattern that is not aligned with either the first axis or the second axis.

14. A system for inkjet printing, comprising:
an inkjet printing module support having one or more inkjet heads disposed thereon, wherein the one or more inkjet heads are configured to move along a first axis;
a substrate stage configured to move along a second axis that is perpendicular to the first axis, wherein the substrate stage is configured to support a substrate having one or more ink landing positions disposed thereon in a pattern that is not aligned with either the first axis or the second axis; and
a system controller configured to simultaneously move the one or more inkjet heads along the first axis and move the substrate stage along the second axis during a printing operation such that the one or more inkjet heads dispense ink into the ink landing positions.

15. The system of claim 14, wherein the pattern is diagonal.

16. The system of claim 14, wherein the system controller is configured to move the one or more inkjet heads in one of a forward direction and a reverse direction along the first axis during the printing operation.

17. The system of claim 14, the system controller is configured to move the substrate stage in one of a forward direction and a reverse direction along the second axis during the printing operation.

18. The system of claim 14, wherein the system controller is configured to move the substrate stage toward the inkjet printing module support while keeping the one or more inkjet heads stationary such that a first ink from a first inkjet head is dispensed into a first ink landing position; and to move the substrate stage toward the inkjet printing module support and move the first inkjet head along the first axis toward a second ink landing position such that a second ink from the first inkjet head is dispensed into the second ink landing position.

19. The system of claim 18, wherein the first inkjet head is moved by a distance equivalent to the x component of the distance between the first ink landing position and the second ink landing position.

20. The system of claim 18, wherein the system controller is configured to move the substrate stage by a distance equivalent to the y component of the distance between the first ink landing position and the second ink landing position, while moving the first inkjet head by a distance equivalent to the x component of the distance between the first ink landing position and the second ink landing position.
